(19) United States
(12) Patent Application Publication
(10) Pub. No.: US 2024/0365198 A1
(43) Pub. Date: Oct. 31, 2024

(54) ENHANCED MULTI-LINK OPERATION (MLO) FOR CLIENT DISTRESS OPERATION

(71) Applicant: Cisco Technology, Inc., San Jose, CA (US)

(72) Inventors: Vinay SAINI, Bandalore (IN); Robert E. BARTON, Richmond (CA); Jerome HENRY, Pittsboro, NC (US)

(73) Assignee: Cisco Technology, Inc., San Jose, CA (US)

(21) Appl. No.: 18/308,299

(22) Filed: Apr. 27, 2023

(51) Int. Cl. H04W 36/32; H04W 36/08; H04W 36/20; H04W 48/16

(52) U.S. Cl. CPC H04W 36/32; H04W 36/08; H04W 36/20; H04W 48/16

(57) ABSTRACT

Enhanced Multi-Link Operation (MLO) for client distress operation may be provided. It may be determined that a client device is approaching an edge of a cell. A list of Access Points (APs) that the client device may hear may then be received from the client device. Next, a plurality of APs may be selected from the list. Then a rescue channel to be used by the plurality of APs may be orchestrated. The client device may then be caused to transmit on the rescue channel to the plurality of APs. An original message may be reconstructed from duplicate copies of Uplink (UL) frames received by the plurality of APs on the rescue channel.

### TECHNICAL FIELD

The present disclosure relates generally to providing enhanced Multi-Link Operation (MLO) for client distress operation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing enhanced Multi-Link Operation (MLO) for client distress operation;

FIG. 2 is a flow chart of a method for providing enhanced Multi-Link Operation (MLO) for client distress operation;

FIG. 3A is a diagram illustrating the orchestration of the rescue channel;

FIG. 3B is a diagram illustrating the reconstruction of the original signal; and

FIG. 4 is a block diagram of a computing device.

### DETAILED DESCRIPTION

### Overview

Enhanced Multi-Link Operation (MLO) for client distress operation may be provided. It may be determined that a client device is approaching an edge of a cell. A list of Access Points (APs) that the client device may hear may then be received from the client device. Next, a plurality of APs may be selected from the list. Then a rescue channel to be used by the plurality of APs may be orchestrated. The client device may then be caused to transmit on the rescue channel to the plurality of APs. An original message may be reconstructed from duplicate copies of Uplink (UL) frames received by the plurality of APs on the rescue channel.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wi-Fi 7 may include the Multi-Link Operation (MLO) operation mode allowing a client device to connect with different access radios of a given AP. Wi-Fi 8 may further enhance this feature where a client device may connect with different radios of different Access Points (APs). While the standard may be considering normal client device operations to be where multiple APs surround a client device, it this may not recognize the needs of a client device at the cell edge. In such conditions, the client device may have only a marginal connection to a single AP and may not have a better AP to roam to (e.g., in a make-before-break fashion). This issue may be particularly sensitive in industrial settings, where client device density may be low, but reliability may be critical.

Thus, there may be a need to enhance the MLO mechanism so as to increase the reliability of traffic coming from client devices at the cell edge. Accordingly, embodiments of the disclosure may allow a secondary radio (e.g., in the 2.4 GHz band) to be used, and the surrounding APs to function as a rescue group to provide support to the client device at the edge of a cell.

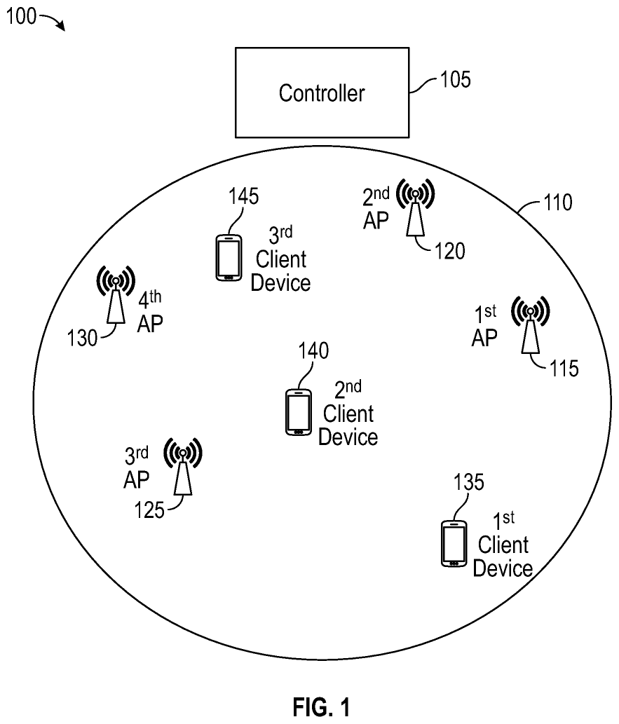

FIG. 1 shows an operating environment 100 providing enhanced Multi-Link Operation (MLO) for client distress operation. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125, and a fourth AP 130. The plurality of APs may provide wireless network access to a plurality of client devices as they move within coverage environment 110. The plurality of client devices may comprise, but are not limited to, a first client device 135, a second client device 140, and a third client device 145. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi-Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band.

Controller 105 may comprise a Wireless Local Area Network controller (WLC) and may provision and control coverage environment 110 (e.g., a WLAN). Controller 105 may allow first client device 135, second client device 140, and third client device 145 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide enhanced MLO for client distress operation.

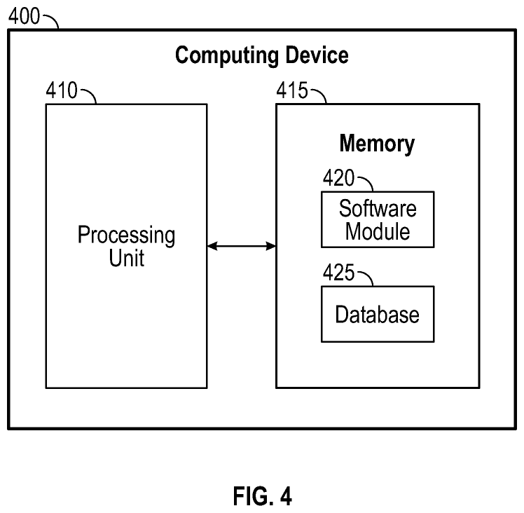

The elements described above of operating environment 100 (e.g., controller 105, first AP 115, second AP 120, third AP 125, fourth AP 130, first client device 135, second client device 140, or third client device 145) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

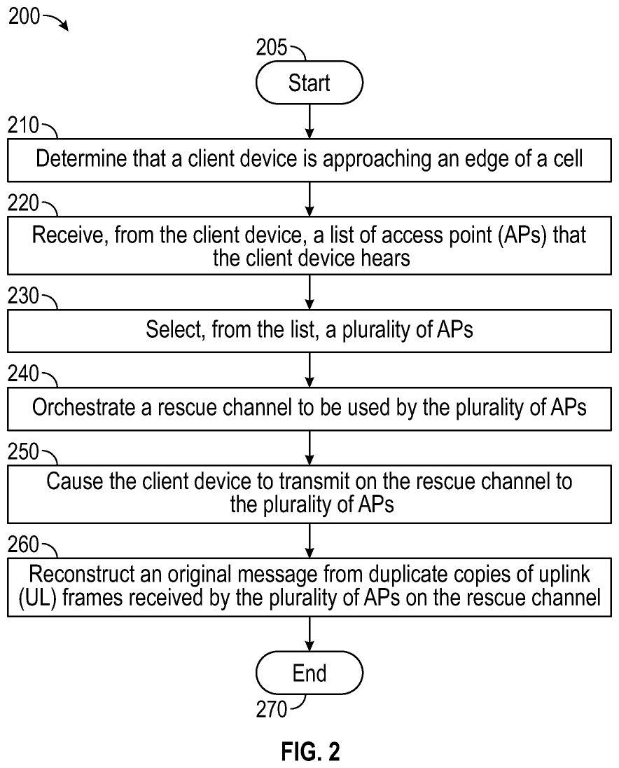

FIG. 2 is a flow chart setting forth the general stages involved in a method 200 consistent with embodiments of the disclosure for providing enhanced MLO for client distress operation. Method 200 may be implemented using computing device 400 (e.g., controller 105 or first AP 115) as described in more detail above with respect to FIG. 1. Ways to implement the stages of method 200 will be described in greater detail below.

Method 200 may begin at starting block 205 and proceed to stage 210 where computing device 400 may determine that first client device 135 is approaching an edge of a cell (e.g., coverage environment 110). For example, first client device 135 may be associated with first AP 115. First client device 135 may be tracked by first AP 115 or controller 105 to be approaching the cell edge (i.e., the edge of coverage environment 110). First client device 135 may also notice that it is approaching the cell edge where an acceptable roaming candidate AP may not be found. In such a case, first client device 135 may send a distress signal to its home AP (e.g., first AP 115 to which it is associated). In either case, either first AP 115 or controller 105 may elevate a warning that first client device 135 is dropping below an acceptable Signal to Noise Ratio (SNR) and may need further support.

From stage 210, where computing device 400 determines that first client device 135 is approaching the edge of the cell, method 200 may advance to stage 220 where computing device 400 may receive, from first client device 135, a list of Access Points (APs) that first client device 135 may hear. For example, controller 105 or first AP 115 may determine if first client device 135 needs help. First AP 115 may ask first client device 135 to provide its list (e.g., 802.11k list) of nearby visible APs as first client device 135 approaches the edge of the cell, but before losing connectivity.

Once computing device 400 receives, from first client device 135, the list of APs that first client device 135 may hear in stage 220, method 200 may continue to stage 230 where computing device 400 may select, from the list, a plurality of APs (i.e., the rescue group). For example, based on the list received from first client device 135, controller 105 or first AP 115 may select a minimal number of surrounding or nearby APs that may hear client devices, but may not be considered good enough for roaming purposes. These APs may be considered the rescue group. In an industrial setting, for example, it may be expected that most APs at the edge of a coverage zone and near a coverage gap may be identified this way. The list may thus be built only once per edge.

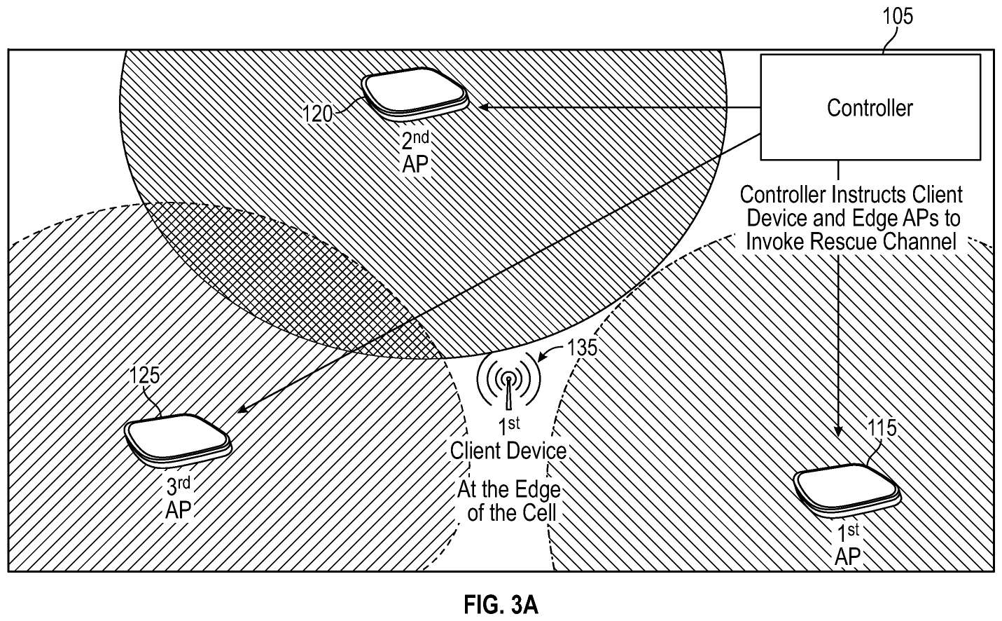

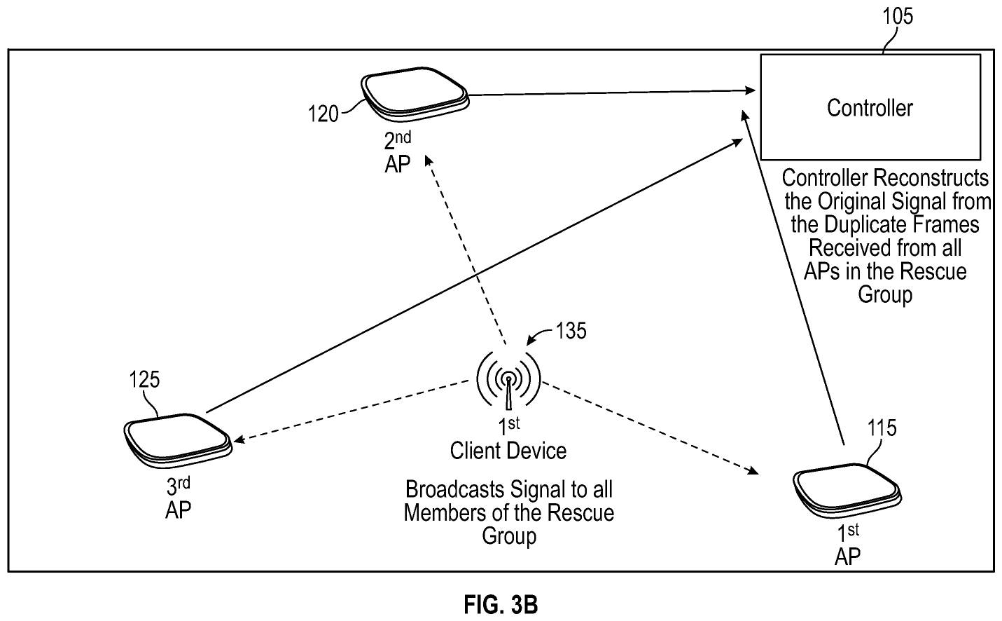

After computing device 400 selects, from the list, the plurality of APs in stage 230, method 200 may proceed to stage 240 where computing device 400 may orchestrate a rescue channel to be used by the plurality of APs. For example, as illustrated by FIG. 3A, controller 105 may centrally orchestrate the rescue channel to be used by the surrounding APs (i.e., the rescue group) in support of this first client device 135. The rescue channel may be a specially reserved channel used by coverage environment 110 (e.g., the WLAN) for this purpose in a lower band, such as 2.4 GHz band. In another embodiment, the APs the rescue group may set their monitor radios on the designated rescue channel. Neighboring APs in the rescue group at the edge of the coverage zone may be set to the same rescue channel.

Once computing device 400 orchestrates the rescue channel to be used by the plurality of APs in stage 240, method 200 may continue to stage 250 where computing device 400 may cause first client device 135 to transmit on the rescue channel to the plurality of APs. For example, using an enhanced Basic Service Set (BSS) Transition Management (BTM) message, first AP 115, to which first client device 135 is associated, may inform first client device 135 to also begin transmitting on the special rescue channel. The rescue channel may not be used by other APs in the area to avoid interference. First client device 135 may also inform first client device 135 of the target associated Basic Service Set Identifier (BSSID). First client device 135 may begin transmitting on the rescue channel and it may also continue sending and receiving on the existing channel.

After computing device 400 causes first client device 135 to transmit on the rescue channel to the plurality of APs in stage 250, method 200 may proceed to stage 260 where computing device 400 may reconstruct an original message from duplicate copies of Uplink (UL) frames received by the plurality of APs on the rescue channel. For example, the participating APs in the rescue group may now all become distributed receivers of the signal. In other words, the surrounding rescue APs in the rescue group may all hear the transmission from first client device 135 at the edge of the cell. In other words, each AP in the rescue group may receive a duplicate copy of the UL frames. Due to poor SNR, errors may exist in some of the copies of the frame.

As illustrated by FIG. 3B, all duplicate copies of the frame may be sent from the participating APs in the rescue group to the primary AP to which first client device 135 is associated (e.g., first AP 115). First AP 115 may reconstruct the original message by extrapolation from the multiple copies. If a valid copy of the original message may be constructed, the associated AP (e.g., first AP 115) may send a delayed Acknowledgement (ACK) back to first client device 135. In another embodiment, controller 105 may receive the duplicate copies and reconstruct the original message. Once computing device 400 reconstruct the original message from duplicate copies of UL frames received by the plurality of APs on the rescue channel in stage 260, method 200 may then end at stage 270.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing enhanced Multi-Link Operation (MLO) for client distress operation as described above with respect to FIG. 2. Computing device 400, for example, may provide an operating environment for controller 105, first AP 115, second AP 120, third AP 125, fourth AP 130, first client device 135, second client device 140, or third client device 145. Controller 105, first AP 115, second AP 120, third AP 125, fourth AP 130, first client device 135, second client device 140, or third client device 145 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
determining that a client device is approaching an edge of a cell;
receiving, from the client device, a list of Access Points (APs) that the client device hears;
selecting, from the list, a plurality of APs;
orchestrating a rescue channel to be used by the plurality of APs;
causing the client device to transmit on the rescue channel to the plurality of APs; and
reconstructing an original message from duplicate copies of Uplink (UL) frames received by the plurality of APs on the rescue channel.

2. The method of claim 1, wherein determining that the client device is approaching the edge of the cell comprises determining that the client device is approaching the edge of the cell in response to receiving a restress signal from the client device.

3. The method of claim 1, wherein determining that the client device is approaching the edge of the cell comprises determining that the client device is approaching the edge of the cell in response to determining that the client device has dropped below a predetermined Signal to Noise Ratio (SNR).

4. The method of claim 1, wherein selecting the plurality of APs comprises selects a minimal number of nearby APs that hear the client device, but are not considered good enough for roaming purposes.

5. The method of claim 1, wherein the rescue channel is specially reserved.

6. The method of claim 1, wherein the rescue channel is in the 2.4 GHz band.

7. The method of claim 1, wherein causing the client device to transmit on the rescue channel comprises using a Basic Service Set (BSS) Transition Management (BTM) message.

8. The method of claim 1, wherein reconstructing the original message from the duplicate copies of the UL frames comprises using extrapolation from the duplicate copies.

9. A system comprising:
a memory storage; and
a processing unit coupled to the memory storage, wherein the processing unit is operative to:
determine that a client device is approaching an edge of a cell;
receive, from the client device, a list of Access Points (APs) that the client device hears;
select, from the list, a plurality of APs;
orchestrate a rescue channel to be used by the plurality of APs;
cause the client device to transmit on the rescue channel to the plurality of APs; and
reconstruct an original message from duplicate copies of Uplink (UL) frames received by the plurality of APs on the rescue channel.

10. The system of claim 9, wherein the processing unit being operative to determine that the client device is approaching the edge of the cell comprises the processing unit being operative to determine that the client device is approaching the edge of the cell in response to receiving a restress signal from the client device.

11. The system of claim 9, wherein the processing unit being operative to determine that the client device is approaching the edge of the cell comprises the processing unit being operative to determine that the client device is approaching the edge of the cell in response to determining that the client device has dropped below a predetermined Signal to Noise Ratio (SNR).

12. The system of claim 9, wherein the processing unit being operative to select the plurality of APs comprises the processing unit being operative to select a minimal number of nearby APs that hear the client device, but are not considered good enough for roaming purposes.

13. The system of claim 9, wherein the rescue channel is specially reserved.

14. The system of claim 9, wherein the rescue channel is in the 2.4 GHz band.

15. The system of claim 9, wherein the processing unit being operative to cause the client device to transmit on the rescue channel comprises the processing unit being operative to use a Basic Service Set (BSS) Transition Management (BTM) message.

16. The system of claim 9, wherein the processing unit being operative to reconstruct the original message from the duplicate copies of the UL frames comprises the processing unit being operative to use extrapolation from the duplicate copies.

17. A non-transitory computer-readable medium that stores a set of instructions which when executed perform a method executed by the set of instructions comprising:
determining that a client device is approaching an edge of a cell;
receiving, from the client device, a list of Access Points (APs) that the client device hears;
selecting, from the list, a plurality of APs;
orchestrating a rescue channel to be used by the plurality of APs;
causing the client device to transmit on the rescue channel to the plurality of APs; and
reconstructing an original message from duplicate copies of Uplink (UL) frames received by the plurality of APs on the rescue channel.

18. The non-transitory computer-readable medium of claim 17, wherein determining that the client device is approaching the edge of the cell comprises determining that the client device is approaching the edge of the cell in response to receiving a restress signal from the client device.

19. The non-transitory computer-readable medium of claim 17, wherein determining that the client device is approaching the edge of the cell comprises determining that the client device is approaching the edge of the cell in response to determining that the client device has dropped below a predetermined Signal to Noise Ratio (SNR).

20. The non-transitory computer-readable medium of claim 17, wherein reconstructing the original message from the duplicate copies of the UL frames comprises using extrapolation from the duplicate copies.
